(19) United States
(12) Patent Application Publication
(10) Pub. No.: US 2002/0087579 A1
(43) Pub. Date: Jul. 4, 2002

(54) Object universe

(76) Inventors: Alan Chasanoff, New York, NY (US); Rick Ross, Cary, NC (US)

Correspondence Address: Daniel Basov, Chadbourne & Parke LLP, 30 Rockefeller Plaza, New York City, NY, 10112, US

(21) Appl. No.: 09/891,599

(22) Filed: Jun. 25, 2001

Related U.S. Application Data
(60) Provisional application No. 60/213,787, filed on Jun. 23, 2000.

(51) Int. Cl. G06F 7/00

(52) U.S. Cl. 707/104.1

(57) ABSTRACT

A method, computerized system and Graphical User Interface for creating storing, manipulating and visually depicting heterogeneous multimedia data items, as well as for depicting, identifying, defining and analyzing the relationships between data items. In the preferred embodiment, the data items are clustered into classification data clusters, Master Facets, which may also be interconnected and the relationships for which may also be defined, analyzed and graphically depicted. The nature of the relationships between data items may be any kind of Boolean, logical or even illogical connection or association that is unique to the user.

The contents of the data items may be viewed while the links and relationships of these items to other items may be explored, analyzed and/or created. The icons representing different types of attributes allow for a quick assignment of a particular attribute to an item or relationship by a simple “drag and drop” technique.

The expert-system software component of the invention analyzes the existing relationships between data items and assists in creating and defining new relationships between data items based on the data acquired from the analysis of the existing (defined) relationships.

This application claims priority under 35 U.S.C. § 119(e) from a provisional Application No. 60/213,787 filed on Jun. 23, 2000.

### FIELD OF THE INVENTION

The present invention pertains in general to the object-oriented data storage and manipulation of objects and relationships between objects, and more particularly, to an environment and method for establishing, depicting, exploring and analyzing relationships among multimedia data items that contain user input regarding the existence and/or the nature or characteristics of particular objects and their relationships with other objects.

### BACKGROUND OF THE INVENTION

Traditional methods of storing and classifying data involve the use of digital “files”. A file is the fundamental storage unit in a computer operating system. It allows information to be organized and classified, and facilitates data storage, retrieval and processing. Related files may be grouped together in macro files, which can in turn be classified, stored and retrieved.

While a file structure is ideal for storing and classifying information, the extent to which files can be linked or interrelated is limited. Files and the information contained therein can be joined only to the extent that the information is grouped together in the same common file. The hierarchical structure that characterizes a filing system is not conducive to establishing relationships amongst disparately filed information.

A database is a species of filing system that allows various data items to be stored in different categories, which may correspond to the files of a traditional hierarchical filing system. A database is more versatile than a traditional filing system in that it allows data from separate files to be compared, generally to sort the data with a view to achieving an intended result. For example, individuals' name and height information can be related in order to determine all individuals whose names begin with a certain letter and who are over a certain height. The result is that the data items are simply sorted according to input criteria in order to obtain the desired result in the form of selected data items. The relationship between items of information in the database is not separately stored, nor is the database model properly equipped to define and vary relationships, nor permit analysis of their qualitative nature.

In the last decade, the integration of multiple networks into a global computer network, the Internet, tremendously increased the amount of accessible data and proliferated many different formats and types of multimedia files and data items that are typically accessible to an individual user connected to the Internet. However, despite the efforts to simplify navigation and standardize the task of retrieval and presentation of the retrieved information, there is still a great need for a flexible user-friendly and user-definable organizational structure out of the disorganized and unstructured heterogeneous multimedia and data items, such as, among other things, Web pages, different types of images and pictures, text data, audio-visual data, personal thoughts of the user related to the data items and/or methods utilized in navigating or extracting these data items, logical links and relationships between various data items (either inherent or personal for each user), and previously stored or associated relationships between personal items of data that are assigned, created and/or entered by the user. Furthermore, there is a need for a simple GUI (graphical user interface) that allows users to define, assign, create and store different data items and various relationships between these data items either locally, remotely or in a database or structure distributed over a network.

It would be further desirable to provide an environment whereby discrete data items can be stored and classified, and relationships can be established between different items of accessible data, wherein the relationships themselves could be identified, stored and separately classified. Upon establishment of a relationship between items of data, the relationship itself could be stored as a separate informational item, and those relationships that are stored can be independently searched, viewed, re-defined, modified and enhanced.

It would also be desirable to have a GUI (graphical user interface) whereby the relationships between discrete data items can be created, drawn, displayed, edited and modified with simple “drag-and-drop” techniques.

It would be further desirable to have a logical component added to the graphical user interface to guide the identification, the extent and nature of various relationships and logical inter-connections between discrete data items.

Once the logical relationships between various data items are defined, it would be desirable to provide computerized interactive analytical tools for examining, enhancing, simplifying, modifying and understanding the complex logical connections between multiple data items, as well as suggesting and guiding the creation of additional connections and relationships that are based upon or derived from the relationships already defined and entered by the user.

### SUMMARY OF THE INVENTION

It is therefore an object of the invention to provide a data environment whereby data items (also referred to as objects) can be created, stored, retrieved and linked.

It is a further object of the invention that the environment be capable of accepting multimedia data items such as pictures, audio, images and video.

It is also an object of the invention that the data items can be combined or grouped into one or more classification areas or clusters known as Master Facets.

It is a further object of the invention to permit relationships to be established between discrete data items in different Master Facets, and those relationships identified, classified and searched.

It is another object of the invention to allow creation and establishment of relationships between Master Facets themselves, in addition to the relationships between data items comprising these Master Facets.

It is yet another object of the invention to graphically represent the relationships drawn between discrete data items and/or between Master Facets.

It is further object of the invention to provide a GUI interface for viewing the contents of a data item, together with various links (i.e., relationships) associating that item with other items, as well as their respective relationships with additional items being depicted in the same view, or easily accessible for viewing from the screen depicting either full or partial content of the viewed item.

It is yet further object of the invention to provide a simple interactive user interface to assist and guide users in the process of creating and/or defining relationships between discrete data items and/or between Master Facets.

It is still another object of the invention to provide analytical tools to assist in examining, enhancing, simplifying, modifying and understanding the complex logical connections between multiple data items, as well as suggesting and guiding the creation of additional connections and relationships that are based upon or derived from the relationships that are already defined and entered.

In accordance with these and other objects, the present invention is an environment whereby multimedia data items can be positioned, stored and retrieved, and relationships established between such data items. Multimedia data items can be imported and positioned in the environment, and may be grouped into classification areas or clusters that are termed “Master Facets”. There is no limit to the number of Master Facets that can be created in the environment, nor is there a limit to the number of data items that can be stored in any one Master Facet. All digital data types are supported by the environment, so no external applications are required to view data items.

In a preferred embodiment of the invention, a graphical interface for the environment allows data items to be easily stored and retrieved together with identifying information concerning respective data items. The graphical interface also permits linking and establishing relationships between data items simply by pointing at a data item and dragging a link to another data item. In this way, relationships between discrete data items in different Master Facets can be freely established, and each of these relationships can be separately classified, stored and depicted. Relationships are shown in the graphical environment by lines joining the related data items. The link represents the relationship between data items, and encourages the user to explore by “dragging” links and establishing new relationships between discrete data items.

Upon establishing a relationship between data items, the visual presentation of those items changes to convey the status that they acquire when they become related to other data items or Master Facets. For example, when a data item is first related to another, the data items change from a small square to a graphical line, representing a facet in the Master Facet, and a side of a polygon representing the Master Facet. Master Facets with data items that are heavily related appear graphically denser.

Each of the relationships drawn can be separately stored, annotated and searched. Data items can be intentionally linked, or may become linked indirectly through the intentional linking of intermediate data items. This allows for the computerized detection of existing indirect relationships between data items thought to be unrelated, and enables further recursive analysis of other relationships between data items.

The environment is preferably depicted in two dimensions and is viewable on a computer monitor, although three dimensional views, animated views, textual views, histogram views and other representations are contemplated by the present invention.

These and other objectives, characteristics and advantages of the present invention will be disclosed in more detail with reference to the attached drawings.

### BRIEF DESCRIPTION OF THE DRAWINGS

FIG. 1 is a snap shot of the initial screen for creating, defining and connecting Master Facets in accordance with one embodiment of the invention.

FIG. 2a is a snap shot of the screen illustrating how a new Master Facet is created and depicted in accordance with one embodiment of the invention.

FIG. 2b is a snap shot of the screen depicting how the names, various characteristics, attributes and information associated with a Master Facet may be modified or supplemented in accordance with one embodiment of the invention.

FIG. 2c is a snap shot of a Metadata Entry Dialog (MED) screen with boxes for changing and supplementing the name, various characteristics, attributes and information associated with a Master Facet in accordance with one embodiment of the invention.

FIG. 3a is a snap shot of the screen illustrating how a new item associated with a particular Master Facet is created and depicted in accordance with one embodiment of the invention.

FIG. 3b is a snap shot of the screen depicting how the name, various characteristics, attributes and information associated with an item belonging to a particular Master Facet may be modified or supplemented in accordance with one embodiment of the invention.

FIG. 3c is a snap shot of a Metadata Entry Dialog (MED) screen with boxes for changing and supplementing the name, various characteristics, attributes and information associated with a particular item in accordance with one embodiment of the invention.

FIG. 4 is a snap shot of a Content Browser screen for browsing through and selecting objects and/or files stored in or accessed by the computer executing the Object Universe software in accordance with one embodiment of the invention.

FIG. 5 is a snap shot of a visual representation of multiple Master Facets, with multiple items belonging to each Master Facet in accordance with one embodiment of the invention.

FIGS. 6a and 6b are snap shots of the screens depicting a creation of a link between items associated with separate Master Facets in accordance with one embodiment of the invention.

FIG. 7 is a snap shot of the screen depicting a Master Facet that contains multiple items that are linked to the items grouped under or associated with other Master Facets in accordance with one embodiment of the invention.

FIGS. 8a and 8b are snap shots of the screens depicting how the link (relationship) between items of different Master Facets can be created, modified and supplemented in accordance with one embodiment of the invention.

FIG. 8c is a snap shot of a Metadata Entry Dialog (MED) screen with boxes for changing and supplementing the name, type of association, various characteristics, attributes, and information associated with a particular link (relationship) between items of different Master Facets in accordance with one embodiment of the invention.

FIGS. 9a-9d are snap shots of the screens depicting how the content of one or more items may be viewed and visually presented together with one or more links (relationships) of each of the viewed items with other items in different Master Facets in accordance with one embodiment of the invention.

FIG. 10 is a snap shot of the screen depicting a tree structure screen view for visual presentation and manipulation of multiple Facets, multiple items in each Master Facet and links (relationships) between some of those items in accordance with one embodiment of the invention.

### DETAILED DESCRIPTION OF THE INVENTION

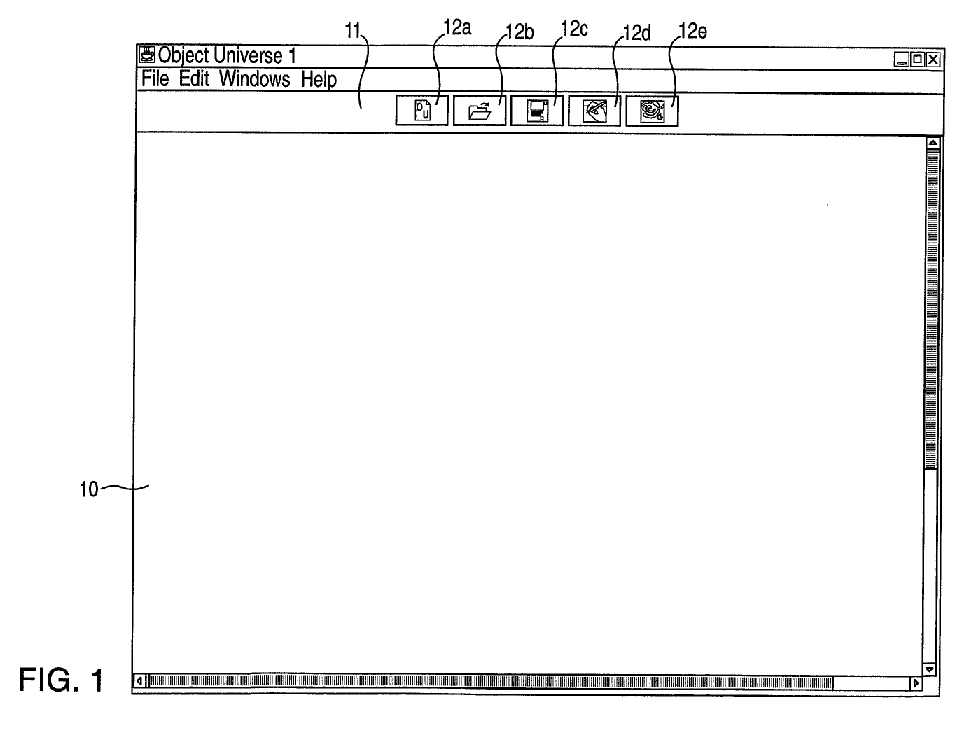

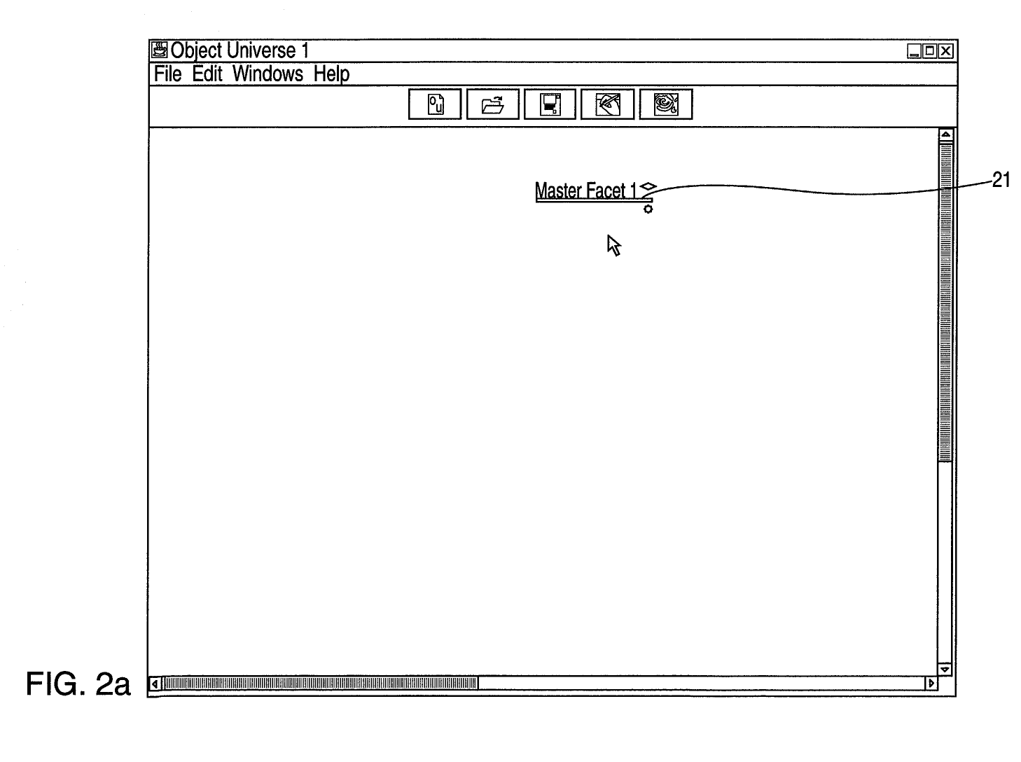

In accordance with one embodiment of the current invention, the method and system of creating, grouping and establishing relationships and visual links between different data objects is described with reference to FIGS. 1-10 and depicts a GUI operating as a software program executed in a personal computer under Microsoft's Windows™ operating system. It is understood that utilization of the current system and method is not limited to a particular hardware or operating system, and may be applied and practiced on a variety of different computer systems, and the software for providing the functionality in accordance with the invention may reside either locally, on a separate server, or could be broken into multiple sub-parts and distributed over a computer network.

### Creating Master Facets and Items

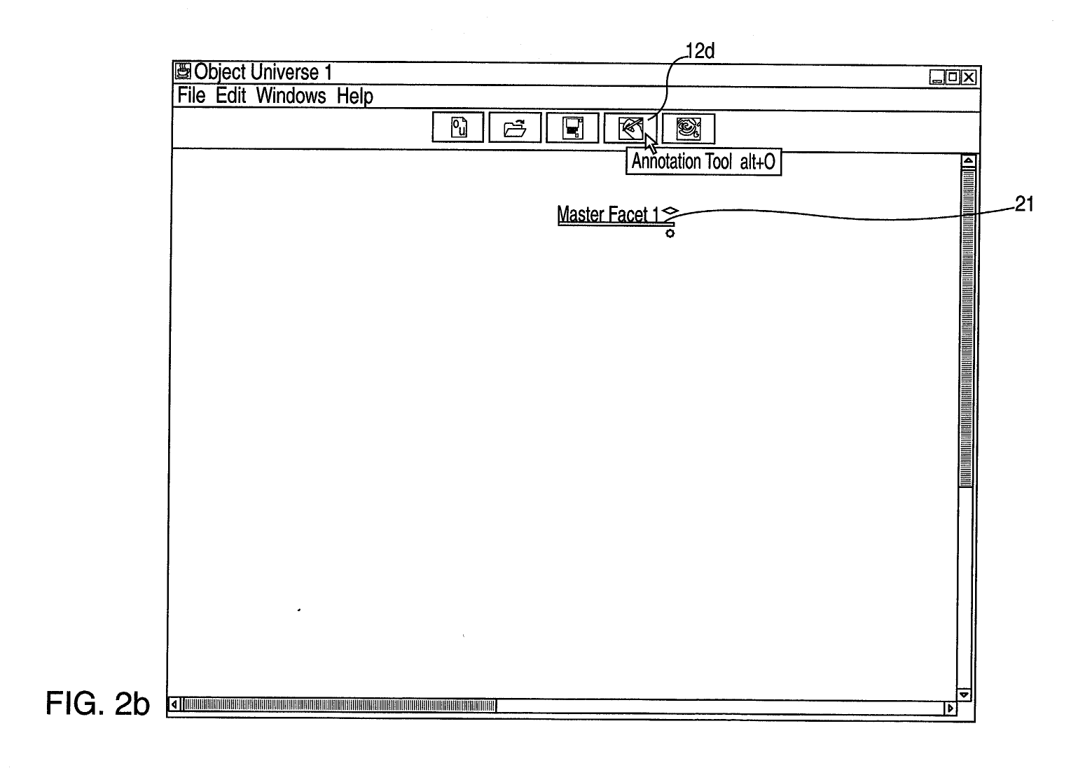

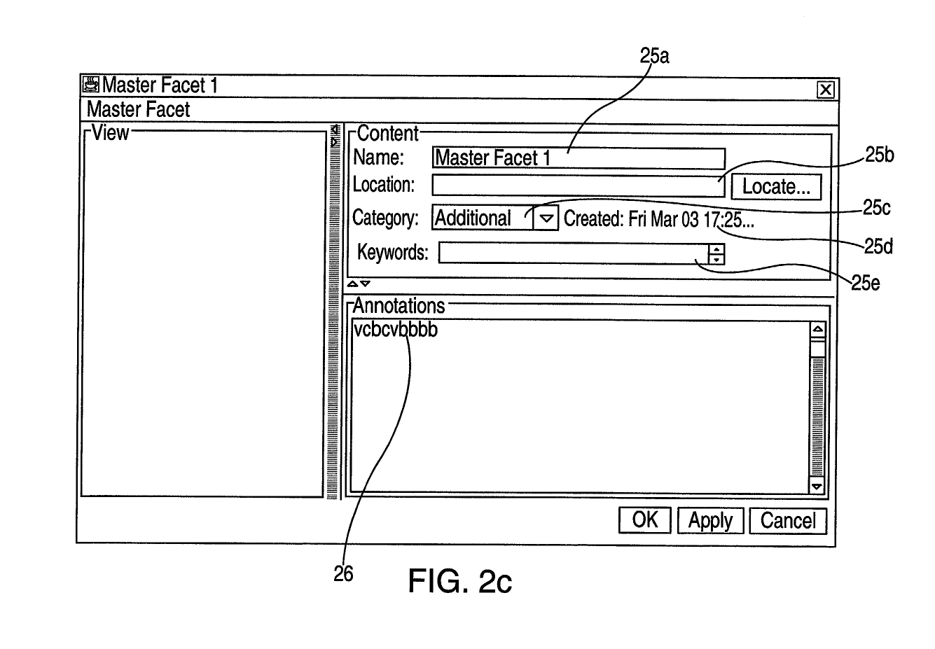

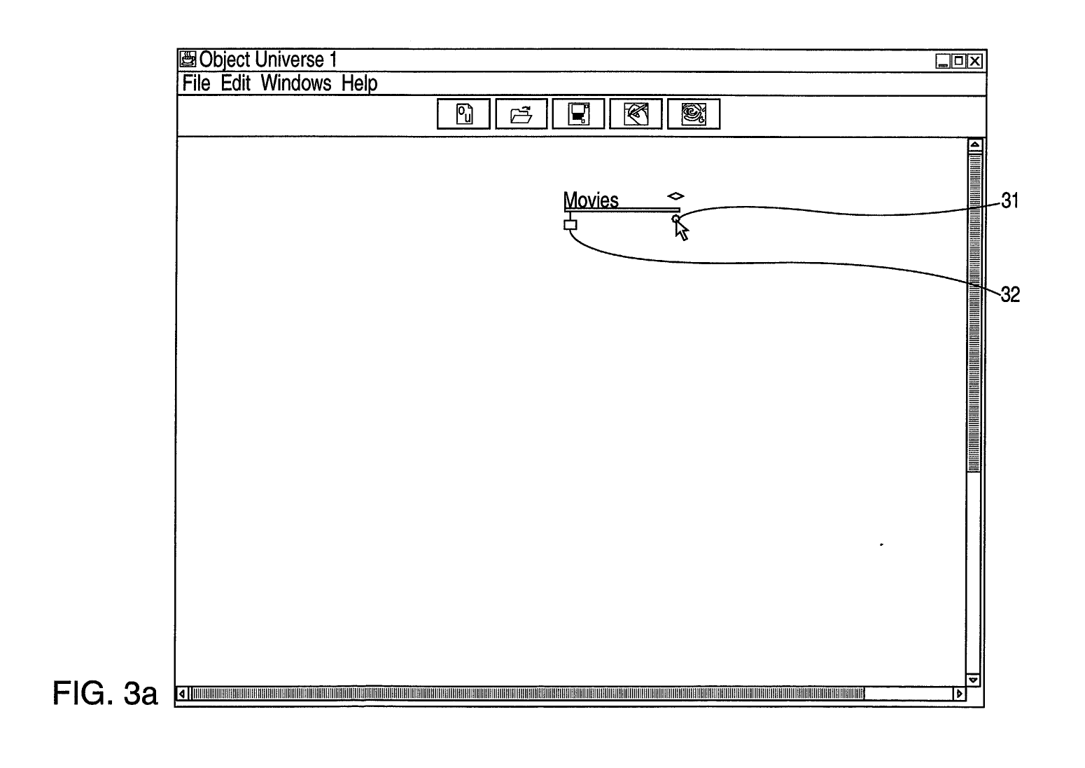

Initially, as shown in FIG. 1, a blank screen 10, with a toolbar 11 having various icons 12a-12e to invoke different functions for creation and manipulation of Master Facets, the items and links (relationships) between items. As shown in FIG. 2a, a Master Facet 21 can be created by double clicking anywhere on the screen, whereupon the Master Facet is then depicted graphically by a thick horizontal line with a circle underneath. While this particular graphical representation of a Master Facet is chosen for the preferred embodiment, it is understood that other types of graphical representation may be suitable and could be utilized without deviating from the nature of the invention.

By clicking on the “annotation tool” icon 12d, as shown in FIG. 2b, the user may assign, create, modify or alter various characteristics of the Master Facet 21. FIG. 2c illustrates the Metadata Entry Dialog (“MED”) box (screen), containing boxes for entering or modifying information associated with a particular Master Facet. The preferred embodiment shown in FIG. 2c illustrates the following attributes that are associated with a Master Facet: the name 25a, location 25b, category 25c, creation date and time 25d, keywords 25e and additional annotations 26, which may contain any comments made by the user or creator of the Master Facet. These comments or annotations are typically very important from a user perspective as they allow to associate certain meaningful terms or definitions with a particular Master Facet.

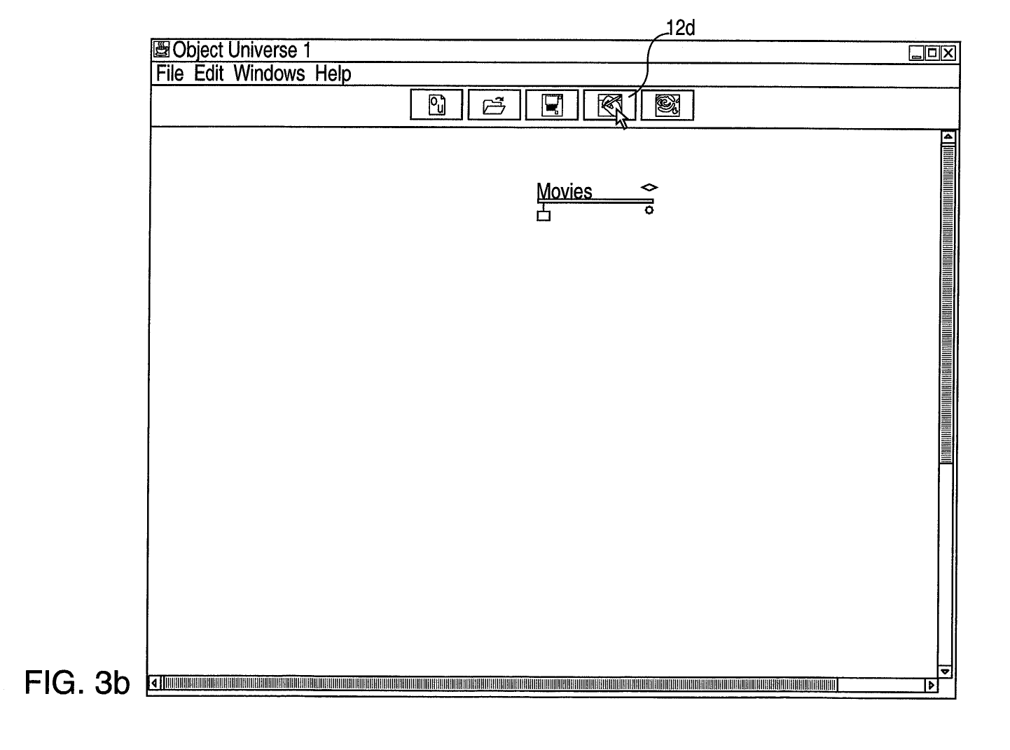

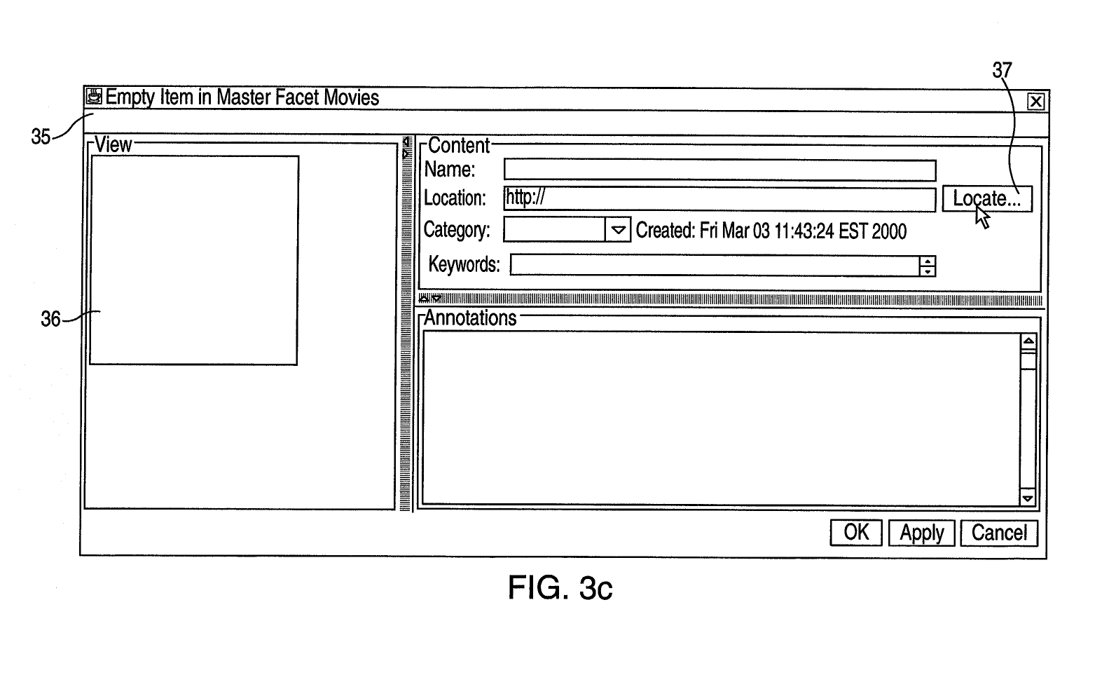

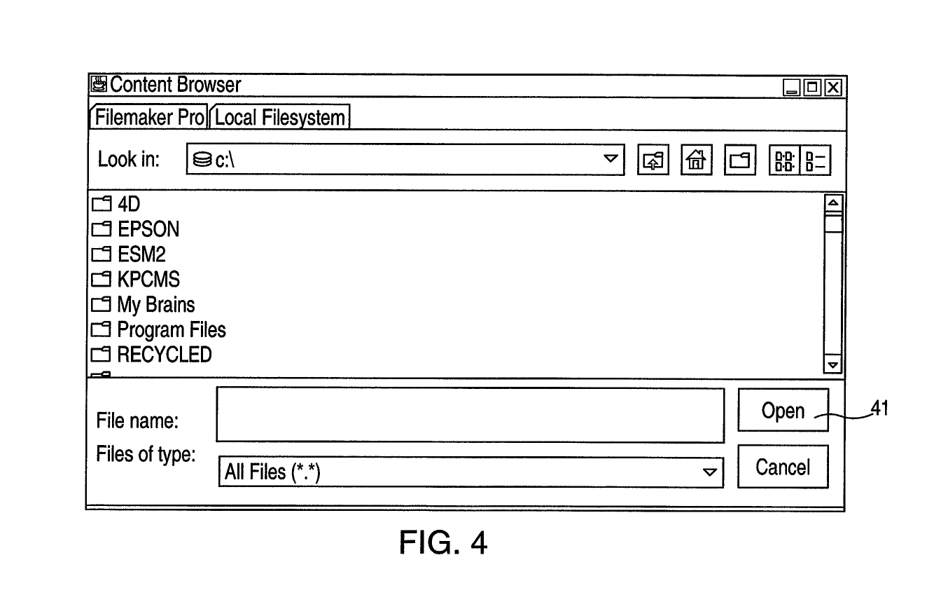

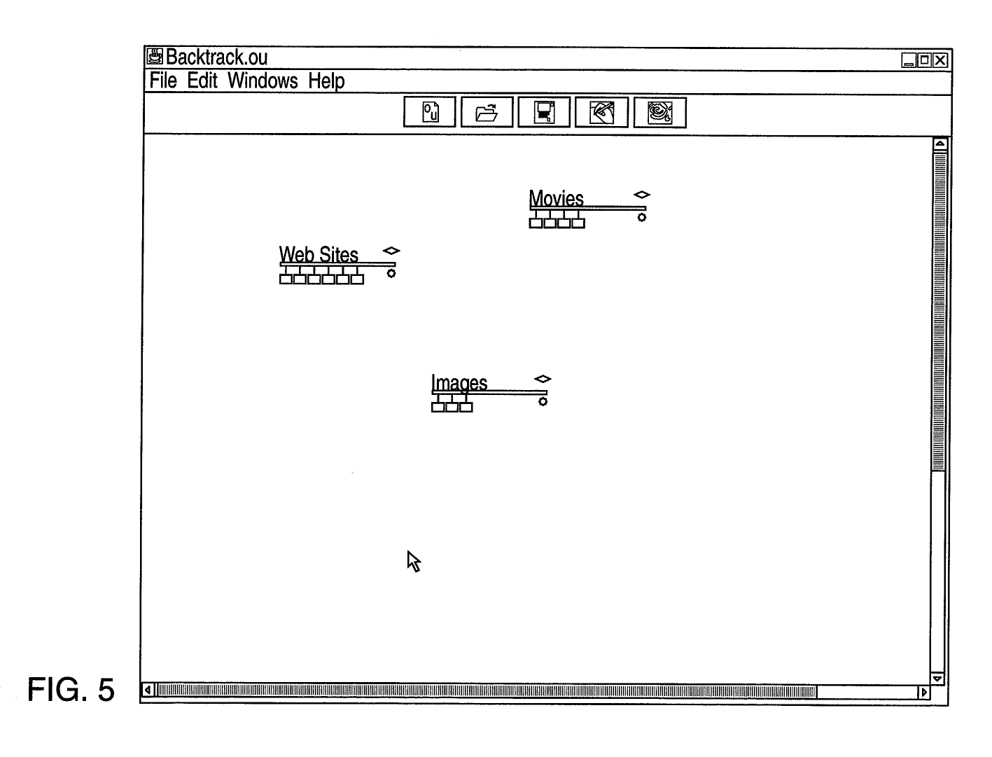

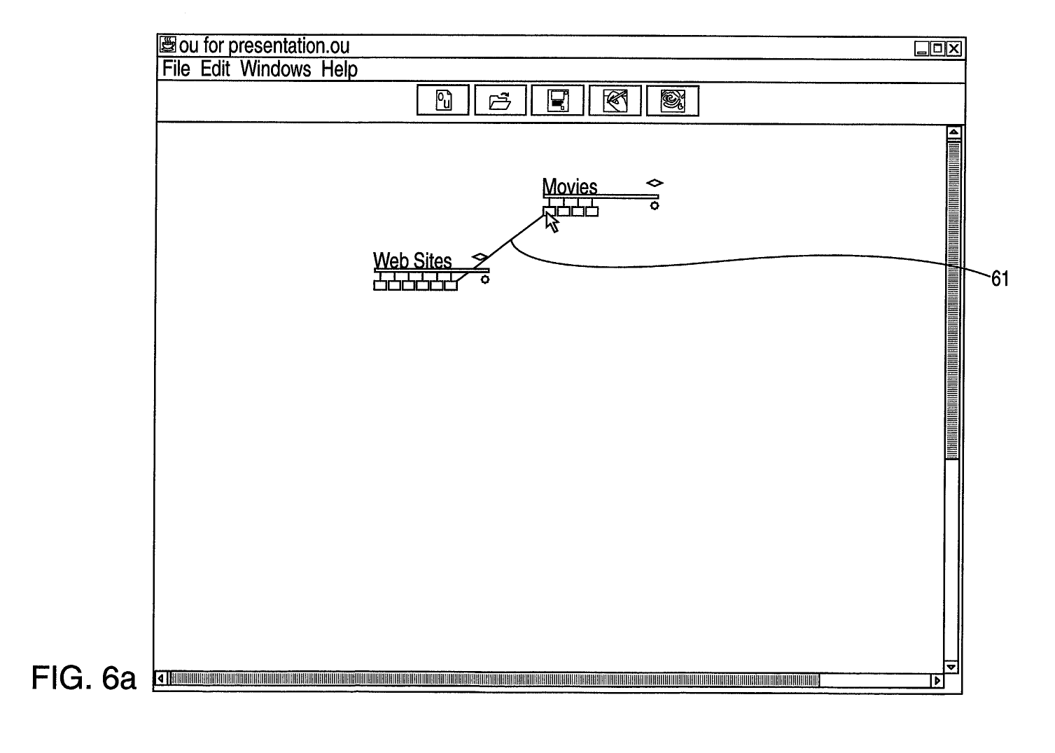

Referring to FIG. 3a, the Master Facet is depicted graphically by a thick horizontal line with a circle 31 underneath. The circle 31, then, can be clicked in order to create an item belonging to the Master Facet. The item 32 appears as a black box joined by a vertical line connecting the box to the horizontal line representing the Master Facet. By clicking on the “annotation tool” 12d icon, as shown in FIG. 3b, the MED box (or screen) appears for the item. Referring to FIG. 3c, the MED box for the item may be distinguished from a similar MED box for the Master Facet by a different title (or name) on the title bar 35. As with the Master Facet, the item can be imported, created, named, renamed and annotated in the MED box, which also includes a preview window 36 to view the content of the item. Data items can be imported using the MED box directly from other files on the system or from the Internet. FIG. 5 illustrates how multiple Master Facets can be created in the environment, and multiple content-based data items created for each Master Facet in accordance with invention. As shown in FIG. 3c, to add locally stored multimedia content such as audio, video, local html files or documents and items from any other application to the item being processed, the user may simply click on the “locate” button 37 on the screen and then navigate through and select from the locally stored files, as shown in FIG. 4 or access data in other applications, and then press the “open” button 41. If an item or file belongs to a particular application, that application may be initiated or started by selecting the item, or alternatively may be executed by clicking on the icon representing an executable program for a particular application, and then opening the item or file from the inside of that application process/window.

### Defining Relationships Between Items

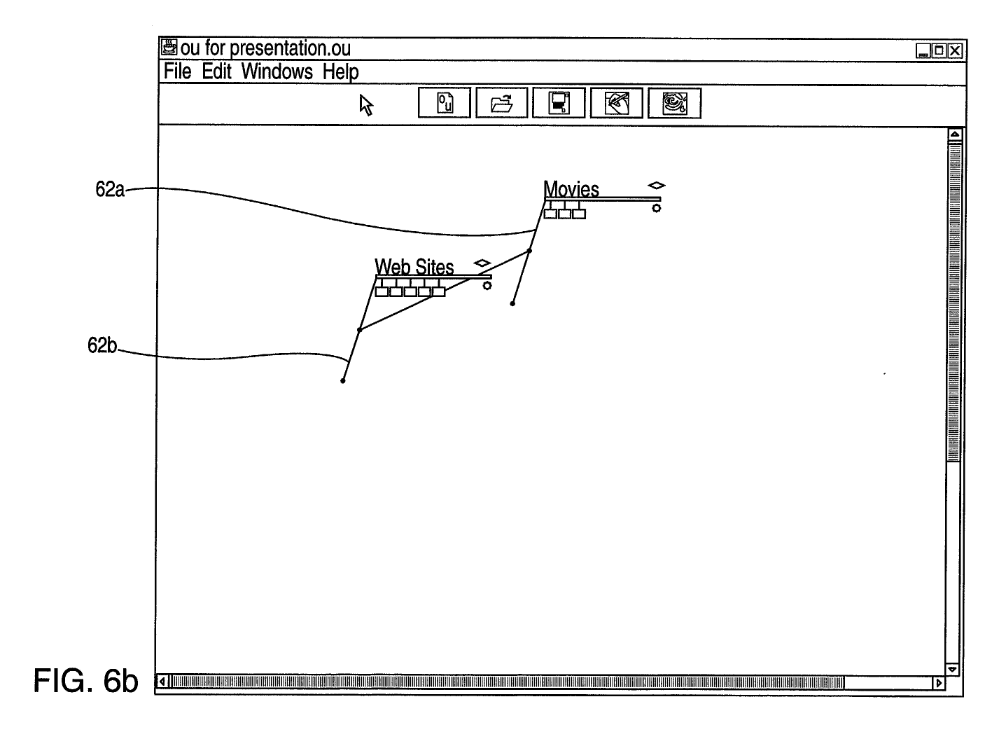

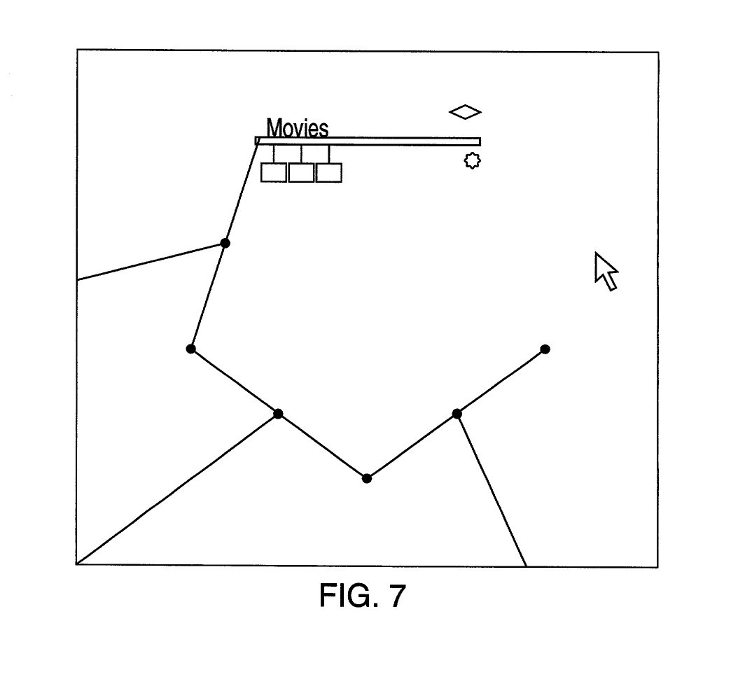

Relationships between discrete data items can be established in the environment by clicking and holding the first item, and dragging the cursor to the second item, the action being shown on a screen as a line 61 connecting related items, as shown in FIG. 6a. Referring to FIG. 6b, when the cursor is released, the black boxes representing items beneath the respective Master Facets become lines 62a and 62b, and those lines are joined by a line 65, preferably of a different color, representing a relationship between the two data items. As more items grouped under or associated with a particular Master Facet become linked, a multi-edge geometrical pattern shown in FIG. 7 is formed around the line representing a particular Master Facet, making a more “mature” (i.e., having more relationships) Master Facet easily discernable on a screen. Preferably, each edge shown in FIG. 7 represents a relationship of an item belonging to that Master Facet to a different item of another Master Facet. It is also understood that relationships between items of the same Master Facet may also be graphically represented on the screen. For example, each item that has a defined relationship with another item under the same Master Facet (other than the fact that it belongs to the same Master Facet), may be represented as having a vertical bar, extending downward from the box representing that item and being joined by a vertical line with a similar vertical bar of a related item. The vertical bars indicating different relationships between different groups of items belonging to the same Master Facet may have different colors and/or join vertical bars of their corresponding data items at different vertical levels. Furthermore, relationships between Master Facets themselves (rather than between items associated with Master Facets) may also represented in a similar manner, as, for example a multi-edge structure described above and shown above the thick horizontal line 21 representing Master Facet and being smaller in size (and having a different color) than that used for representing connections between items, each edge of the multi-edge structure representing a relationship between a particular Master Facet and other Master Facets.

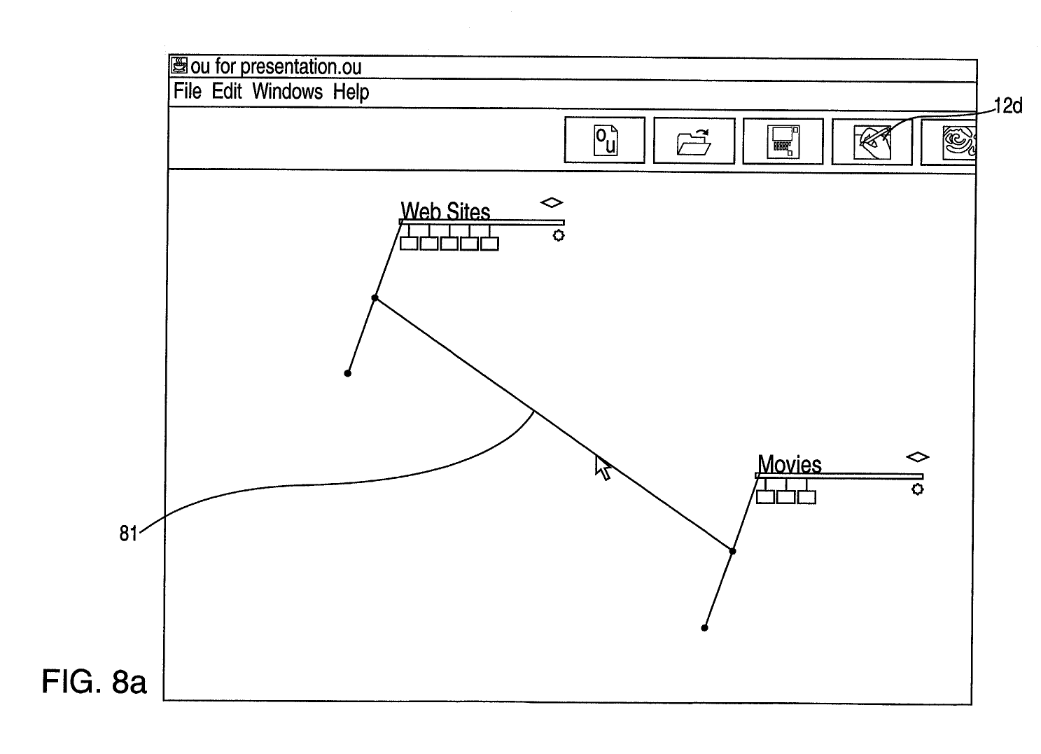

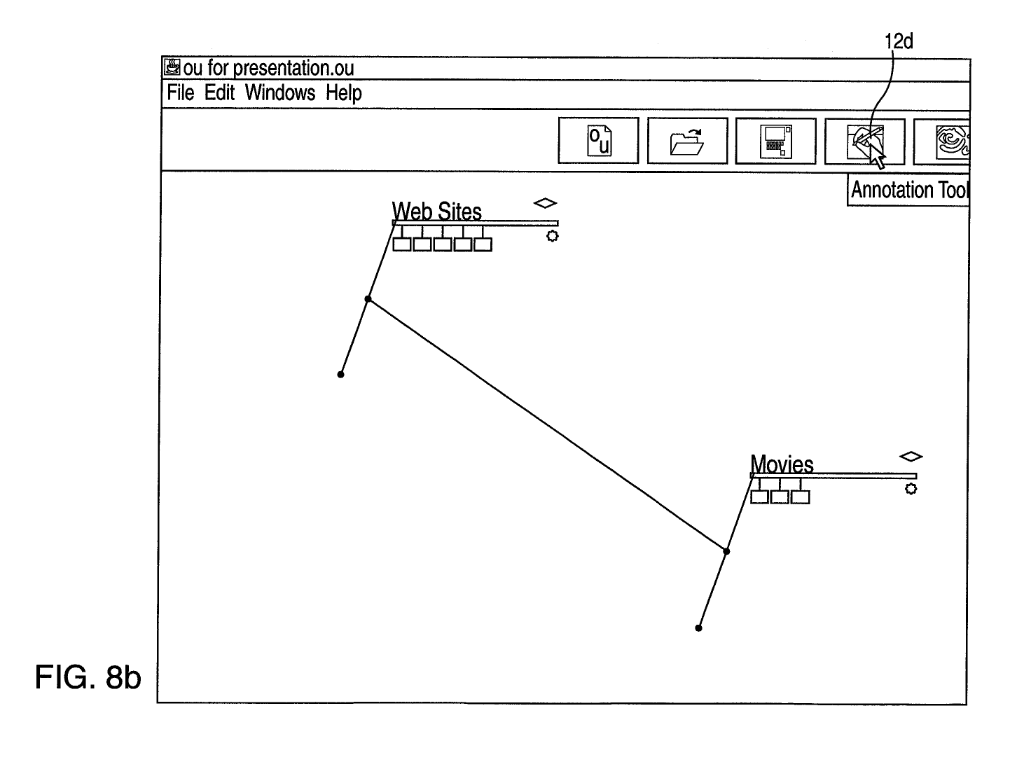

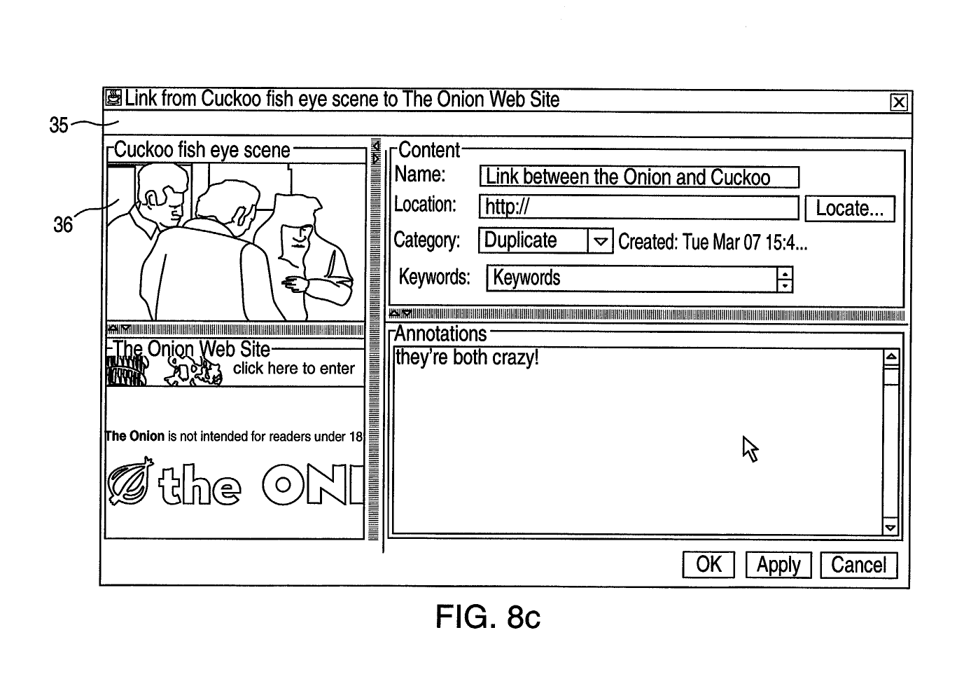

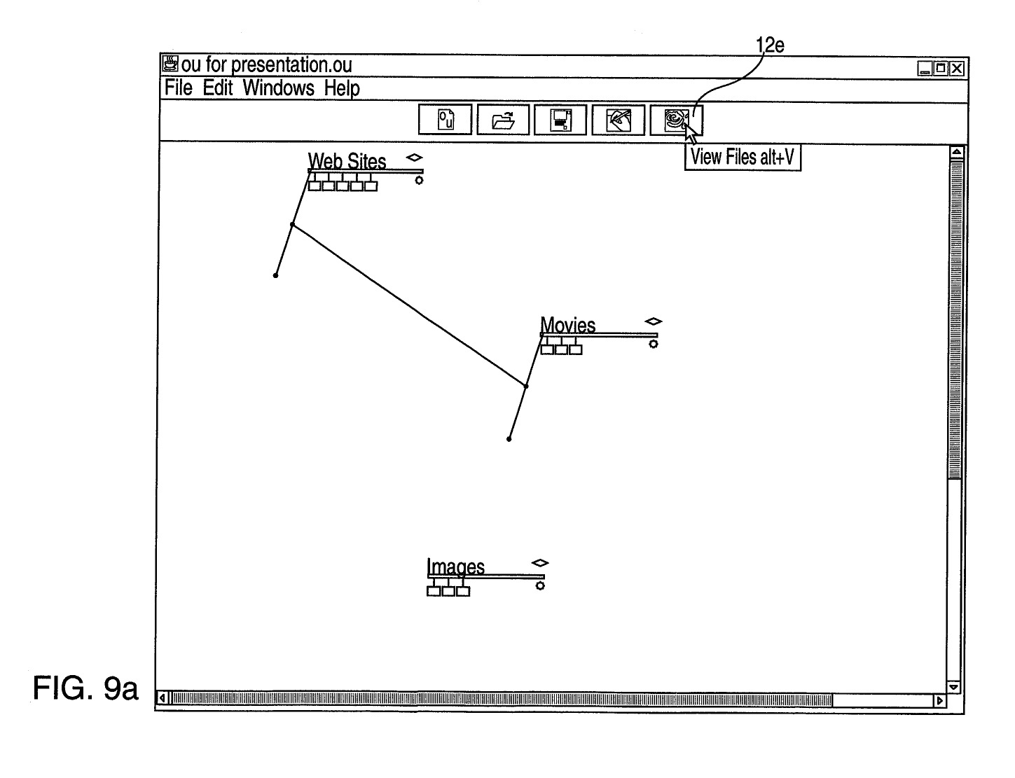

Each relationship has its own MED box, similar to those for each data item and Master Facet. Similarly, these links (relationships) may also be categorized, annotated, defined and analyzed. Referring to FIGS. 8a and 8b, to bring up the link's MED box, the user may simply click or select the link 81 and click on the “annotation tool” icon 12d. Referring now to FIG. 8c, the MED box (screen) for the relationship permits classification and analysis of the relationship. It is distinguished from a MED box for a Master Facet or an item by the description in the title bar 35, which is similar to a title bar for other MED boxes. In the MED screen, the relationship between items can be defined, categorized from previously defined categories, or by defining and selecting new categories. As shown in FIG. 8c, a user may define or modify a relationship by selecting or adding categories in the category box 85b, choosing a name for a relationship in the name box 85a, adding keywords in the keyword box 85e or notes in the annotation box 86, to describe the nature of this relationship, and subsequently clicking on the “OK” button 87 when finished. In addition, the MED box for a relationship allows previewing of each of the linked items in a preview window 36, which simplifies and guides the task of defining new relationships between the linked items. It should be noted that this generalized and flexible approach to defining and re-defining different types of relationships between items is very different from a rigid relational database model, where connections between different tables or rows in a table are pre-defined by a schema set up by a database administrator and typically involves cross referencing through identical (i.e, duplicate) data being stored in different tables and interrelated by a full or partial “equality” operation. In contrast, the relationships defined in a MED box in accordance with the invention may have any kind of Boolean, logical or even illogical connection or association that is unique to that user. Furthermore, the connection between items may be defined (either through meta-tiles or as annotations) only for a limited time period, or subject to constraints due to relationships between other items and/or Master Facets.

Additionally, it is contemplated that an interactive expert system with rules defined for a particular type of application, such as, for example, scientific exploration, finance or gathering of consumer and product information, may generate and/or suggest different types of associations between items, based on previously defined and existing relationships between items and/or Master Facets, together with interactive responses given by a user. Thus, with the growth in the number of different items and expansion of various relationships between different items and Master Facets, the expert system may also be made self-teaching, thereby making its suggestions and guidance to the user more refined and useful as the system becomes more complex. For instance, the expert system may comprise a software component for analyzing various paths between items and/or Master Facets, types of relationships that connect items over different paths and suggest new links, associations or categorizations of items or re-organizations of links previously unknown to the user. Furthermore, the items, Master Facets and relationships defined or perceived by one user may be compared against and/or annotated with those of another user, and their cumulative knowledge base can either be combined together or contrasted against each other. Among many other applications, this feature could be applied to analysis of consumer preferences based on their personal OU definitions, for determining compatibility between different individuals, or, more generally, for sociological and psychological studies of various groups and/or individuals.

### Meta-Tiles (Meta-Attributes) For Master Facets, Items and Relationships

Meta-tiles offer a graphical means to classify data items and relationships in the environment. Meta-tiles are icons representing various data classifications or “meta-attributes” that are either pre-set or that can be created by the user. In one embodiment in accordance with the invention, a separate window with different meta-tiles may be presented to the user, and the meta-tiles can simply be dragged and dropped onto the data items, whereupon the associated meta-attribute will become attached to the data item and the data item be classified in accordance with that meta-attribute. Alternatively, meta-tiles may be different entries in a pull-down menu in the MED box and may be selected for an item, Master Facet and/or link. Once defined, the meta-tiles also become independently searchable components. New meta-tiles could be defined and added to the overall OU system, and may represent any type of meta-attribute imaginable, like, for example, numeric, textual, calendar, Boolean, complex data structures, databases, etc. The meta-tiles allow non-technical users to widely extend and annotate the data items, since the graphical presence of meta-tiles on the screen and the simplicity of the process for attaching meta-attributes to data items by “dragging and dropping” encourages users to explore the association of meta-attributes with a broad range of data items.

### Viewing Stored Content

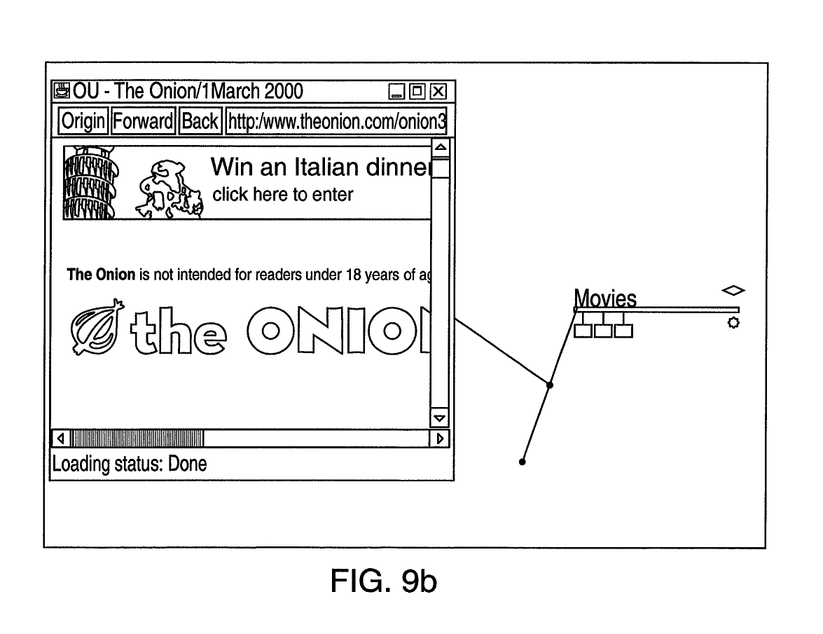

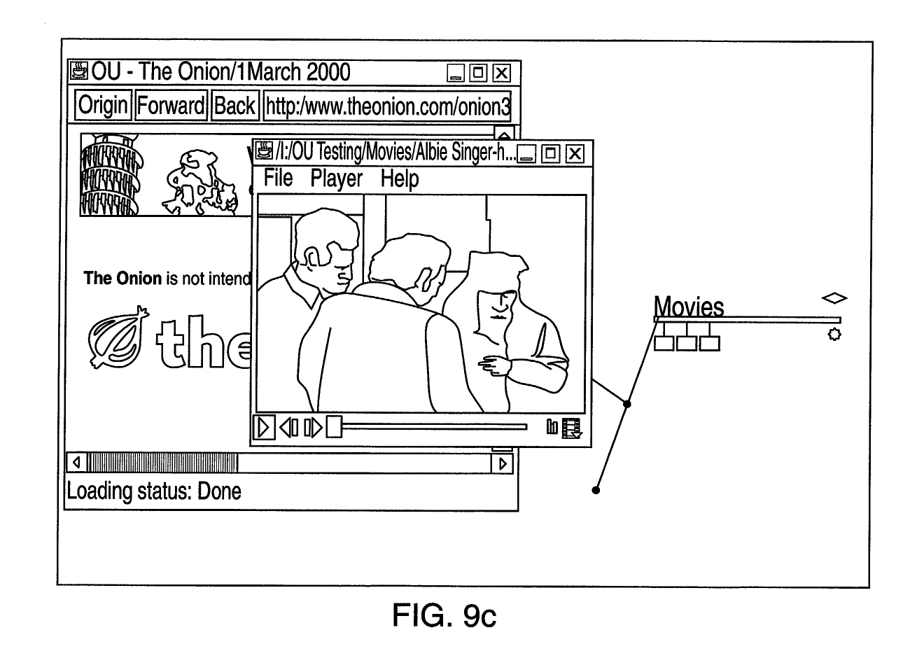

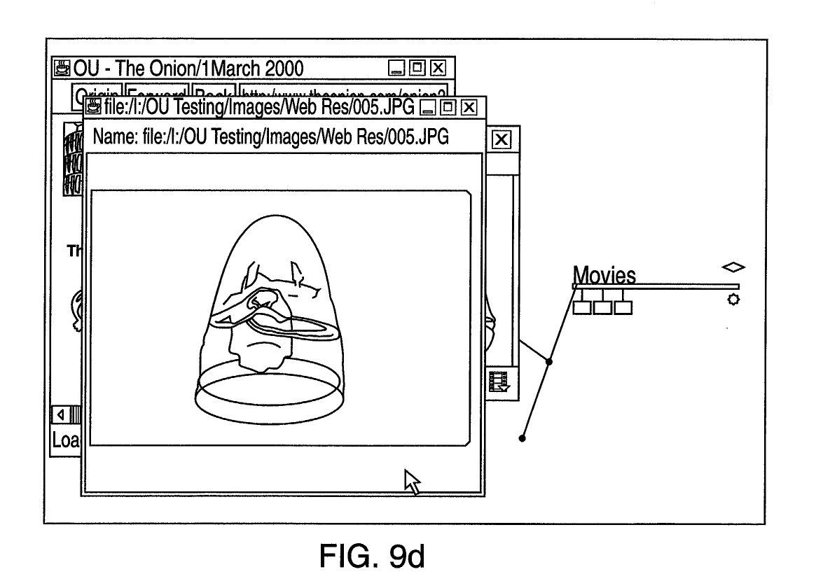

The content of an item could be viewed by simply clicking on the item intended to be viewed, as for example clicking on one of the items of a particular Master Facet, as shown in FIG. 9a, and then clicking the “view file” icon 12e in the tool bar. FIGS. 9b and 9c illustrate how the content of a particular item, such as a Web site and a movie, respectively, may be viewed and displayed together with a link to the related item in another Master Facet. A particular link may be examined in a similar manner, and the content of items that are related may be displayed in separate windows, or, alternatively, side by side in the same window. FIG. 9d illustrates how multiple images showing content of multiple items may be presented on the screen together with a graphical representation of connections between items being viewed and other items.

### Media Strip Data Arrangement And User Interface

The OU (Object Universe) “media strip” is a user interface innovation that is based on one of the oldest data storage systems in the world—the scroll. A media strip connects a virtually limitless number of multimedia viewer cells that are connected in a side-by-side or top-to-bottom sequence, as shown in FIG. 11. In its simplest application, this interface component makes it possible to collect any number of media items into an ordered series. The collection of managed items can be formed from sources of heterogeneous data types, can reside on different computer networks and platforms, and can be stored, retrieved, transmitted, shared, displayed and modified “in situ” using the media strip component. Furthermore, the full suite of tools OU provides for building relations or annotating and accessing “meta-attributes” can be used on any item managed by a media strip, thereby forming a relationship with any other item.

Media strips can also be further extended from their simple, linear form into a tabular or matrix form representing two or more dimensions. The individual cells of a multi-dimensional media strip each have the same properties as in the linear version, but the device gains further value by adding the capacity to form OU links (relationships) between items using a drag and drop context similar to that of the primary OU graphical view. In the tabular format, the rows of the media strip can directly represent the collections of items in a Master Facet, and the relationships between the items and Master Facets can be displayed by connecting lines between cells in the table. Such an enhanced version of the tabular media strip is termed a “connecting viewer” and also constitutes part of the current invention as an alternate mechanism for identifying and accessing the relationships that are the primary focus of the OU data management system.

### Tree View And User Interface

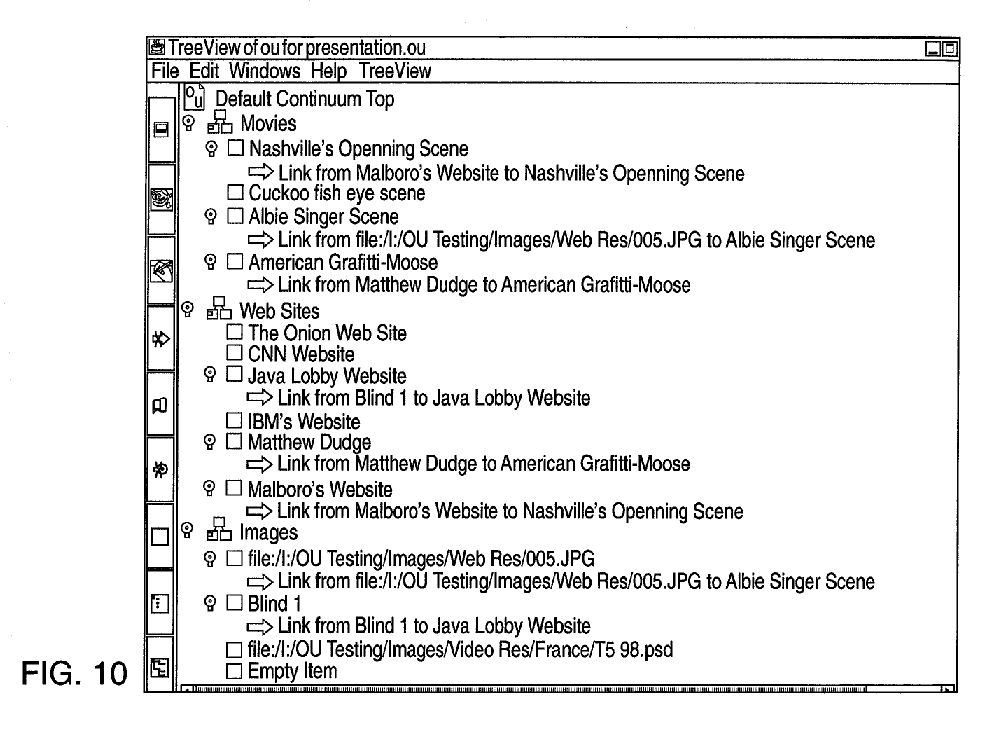

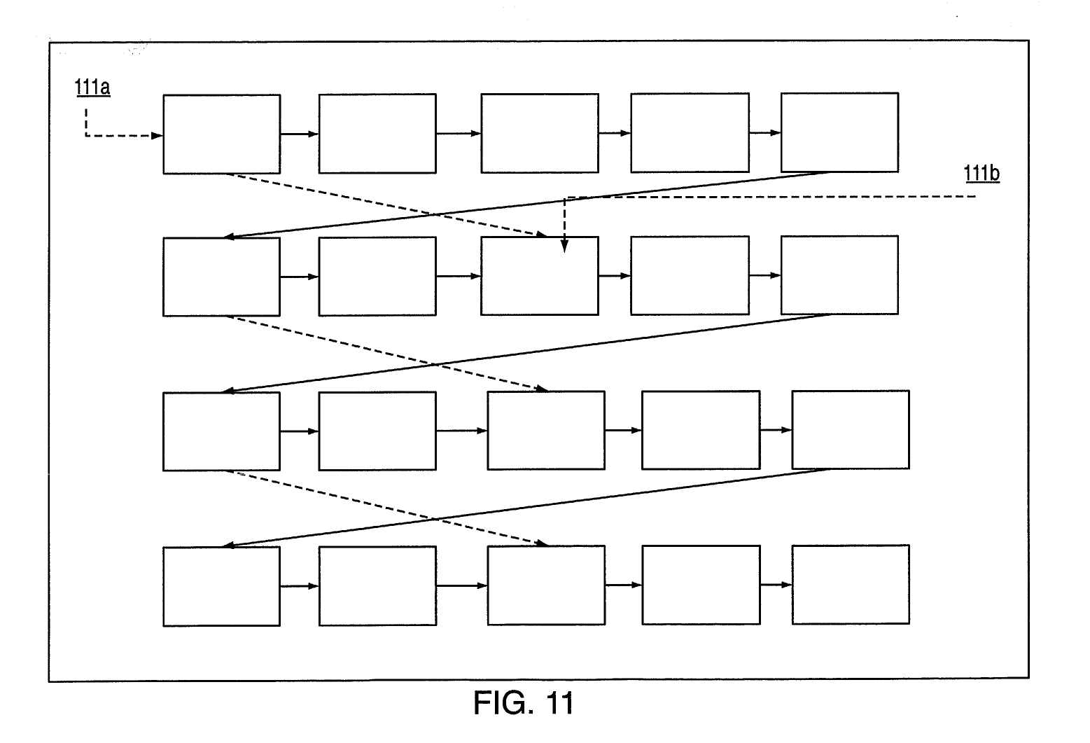

In addition to the various views and graphical representations of the Master Facets, items and relationships described above, the data can also be displayed in a variety of non-graphical means, including a “tree” view, an example of which is illustrated in FIG. 10. The titles of the Master Facets are displayed above the titles of the various data items contained therein, together with graphical representation of the links between items belonging to a particular Master Facet with outside items. By clicking on either the Master Facet, item or link entries shown in the tree view, their respective MED boxes may be brought up on the screen, thus providing for an alternative graphical representation and user interface for creating, accessing, altering and viewing items and relationships. Data and the relationships between data items could then be manipulated, searched and expanded with a goal to viewing, understanding and learning about relationships between data items not related intuitively.

### Temporary Scratch Pad And Coral Storage

Another feature provided by the OU system in accordance with the invention is the ability to “test” certain relationships between items, the so-called “relationship scratch pad”, without committing them to the permanent storage. This function could preferably utilize a separate window, where items may be temporarily connected and their relationships (in view of other relationships) be explored prior to storing the connection and information about logical association between items permanently, i.e., in the computer memory for permanent connection of items and/or Master Facets. In addition, the viewing capability described above allows users to perceive the contents of the items during the process of defining and exploring relationships between them.

Yet another feature of the OU system that supplements the “scratch pad” functionality is the so-called temporary memory “coral” (cache or a temporary file), which stores an item or a Master Facet (with or without items), together with its attributes and meta-tiles in temporary storage, from which it can later be moved to permanent memory and possibly linked to other items and/or Master Facets. This cache storage for items and Master Facets allows the user the flexibility of storing the “hunch” items, Master Facets and/or relationships that may or may not be chosen after some additional exploration or analysis by the user.

While the fundamental novel features of the invention, as applied to embodiments thereof, have been described and pointed out, it should be understood that various omissions, substitutions and changes in the form and details of the invention, as herein disclosed, may be made by those skilled in the art without departing from the spirit of the invention. It is expressly intended that all combinations of these elements and/or method steps, which perform substantially the same function in substantially the same way to achieve the same results, be within the scope of the invention.

We claim:

1. A method for establishing relationships between multiple data items in a computer, comprising the steps of:
creating a graphical representation of at least one data classification cluster Master Facet, said Master Facet utilized for clustering a plurality of related data items;
defining attributes of said Master Facet;
creating a graphical representation of a plurality of data items;
defining attributes of each of said plurality of data items;
clustering a subset of related data items of said plurality of data items under said Master Facet;
displaying visually said clustering of said subset of related data items;
associating at least one data item of said plurality of data items under said Master Facet with another data items by forming a relationship between said data items;
defining attributes of said relationship and perceived logical connection between said data items; and
displaying visually said relationship between said logically connected data items for which the relationship is defined.

2. The method of claim 1, wherein the steps of associating at least one data item of said plurality of data items under said Master Facet with another data item by forming a relationship between said data items and specifying said logical connection between said data items are arbitrarily defined by a user, based on user's perception of the connection between said items.

3. The method of claim 1, further comprising the step of displaying at least partial content of said Master Facet when the attributes of said Master Facet are defined.

4. The method of claim 1, further comprising the step of displaying at least partial content of at least one of said plurality of data items when the attributes of said data item are defined.

5. The method of claim 1, further comprising the step of displaying at least partial content of at least one of said plurality of data items that are associated with each other when said attributes of the relationship between the associated data items are defined.

6. The method of claim 1, further comprising the step of displaying visually every relationship defined for each data item clustered under a Master Facet.

7. The method of claim 6, wherein each visual representation of a relationship defined for each data item clustered under a Master Facet may be independently selected by the user for analysis.

8. The method of claim 1, further comprising the steps of
associating at least one data item of said plurality of data items in a subset clustered under the same Master Facet with another data item clustered under the same Master Facet by forming a relationship between said data items;
defining attributes of said relationship and perceived logical connection between said data items; and
displaying visually said relationship between said logically connected data items for which the relationship is defined;
wherein said logical connection between said data items is other than the fact of being clustered under the same Master Facet.

9. The method of claim 8, further comprising the step of displaying visually every relationship defined for each data item with other data items clustered under the same Master Facet.

10. The method of claim 9, wherein each visual representation of a relationship defined for each data item with other data items clustered under the same Master Facet may be independently selected by the user for analysis.

11. The method of claim 1, further comprising the steps of:
associating said Master Facet with another Master Facet by forming a relationship between said Master Facets;
defining attributes of said relationship and perceived logical connection between said Master Facets; and
displaying visually said relationship between said logically connected Master Facets for which the relationship is defined.

12. The method of claim 11, further comprising the step of displaying the content of at least one of said Master Facets that are associated with each other when said attributes of the relationship between them are defined.

13. The method of claim 11, further comprising the step of displaying visually every defined relationship between said Master Facet and other Master Facets.

14. The method of claim 13, wherein each visual representation of a defined relationship between said Master Facet and other Master Facets may be independently selected by the user for analysis.

15. The method of claim 1, further comprising the step of browsing through the list of data items accessible to the user's computer in order to define the attributes of at least one said data item.

16. The method of claim 1, further comprising the step of viewing at least partial content of at least one data item while displaying visually the relationship link between said data item and at least one other data item.

17. The method of claim 11, further comprising the step of viewing at least partial content of a Master Facet while displaying visually the link between said Master Facet and at least one other Master Facet.

18. The method of claim 1, wherein the executable instructions for carrying out the steps of the invention reside on a local computer of the user.

19. The method of claim 1, wherein the executable instructions for carrying out the steps of the invention reside on a network to which the local computer of the user is connected.

20. The method of claim 1, wherein said data items comprise a plurality of heterogeneous multimedia data objects.

21. The method of claim 1, wherein at least one of said plurality of data items is an audio file.

22. The method of claim 1, wherein at least on of said plurality of data items is a digitized video file.

23. The method of claim 1, wherein at least one of said plurality of data items is an image file.

24. The method of claim 1, wherein at least on of said plurality of data items is an HTML file.

25. The method of claim 1, wherein at least on of said plurality of data items is a text file.

26. The method of claim 1, wherein at least one of said plurality of data items is associated with a particular application.

27. The method of claim 1, wherein at least one of said plurality of data items is a database object.

28. The method of claim 1, further comprising the step of representing a plurality of different types of data item attributes visually and allowing the user to assign said attributes to at least one data item.

29. The method of claim 28, wherein said plurality of different types of data item attributes are represented as icons, and said step of assigning one of said attributes to at least one data item comprises dragging one of said icons and dropping it into a visual representation of said data item.

30. The method of claim 1, further comprising the step of representing a plurality of different types of attributes for data classification clusters visually and allowing the user to assign said attributes to at least one Master Facet.

31. The method of claim 30, wherein said plurality of different types of data attributes for data classification clusters are represented as icons, and said step of assigning one of said attributes to at least one Master Facet comprises dragging one of said icons and dropping it into a visual representation of said Master Facet.

32. The method of claim 1, further comprising the step of representing a plurality of different types of attributes for the relationships and allowing the user to assign said attributes to at least one relationship.

33. The method of claim 32, wherein said plurality of different types of attributes for the relationships are represented as icons, and said step of assigning one of said attributes to the relationship comprises dragging one of said icons and dropping it into a visual representation of said relationship.

34. The method of claim 1, further comprising the steps of analyzing the existing relationships between data items by an expert-system software component and the step of assisting the user in defining the attributes of a new relationship between said data items based on the data acquired from said analysis of said other existing relationships.

35. The method of claim 34, further comprising the step of interactive communications between said expert-system software component and the user, wherein at least one attribute and the nature of at least one relationship between data items that are suggested by the expert-system are at least partially based on a response given by the user.

36. The method of claim 35, wherein the selection of at least one question presented to said user by said interactive expert system component is at least partially dependent upon a prior response given by said user.

37. The method of claim 1, wherein the Master Facets, data items and relationships are visually depicted in a tree format.

38. The method of claim 1, wherein the data items and relationships are visually depicted and organized in a scroll format.

39. The method of claim 1, wherein at least one relationship defined by the user is stored in a scratch pad memory.

40. The method of claim 1, wherein at least one data item is stored in a temporary memory “coral” for connection to other data items at some later time.

41. A Graphical User Interface for a computerized system utilized for creating, retrieving, depicting and managing a plurality of data items comprising:
a graphical representation of at least one data classification cluster Master Facet for clustering a plurality of related data items, said Master Facet having a plurality of attributes defined by a user,
a graphical representation of a plurality of data items, each said item have a plurality of attributes defined by the user, wherein a subset of said plurality of data items is clustered under said Master Facet,
a graphical representation of a relationship between at least one data item of said Master Facet with at least one other data item of another Master Facet, said relationship having a plurality of attributes defined by the user,
wherein the relationship and logical connection between said data items are arbitrarily defined by the user, based on user's perception of the connection between said items.

42. The system of claim 41, wherein at least partial content of at least one of said plurality of data items is displayed when the attributes of said data item are defined.

43. The system of claim 41, wherein at least partial content of the Master Facet is displayed when the attributes of the Master Facet are defined.

44. The system of claim 41, wherein at least partial content of at least one of said plurality of data items that are associated with each other is displayed when said attributes of the relationship between the associated data items are defined.

45. The system of claim 41, further comprising a graphical representation of every relationship that is defined for each data item clustered under a Master Facet, wherein each said relationship may be independently selected by the user for analysis.

46. The system of claim 41, further comprising a graphical representation for a relationship between at least one data item of said plurality of data items in a subset clustered under the same Master Facet with another data item clustered under the same Master Facet, said relationship having a plurality of attributes defined by the user,
wherein said logical connection between said data items is other than the fact of being clustered under the same Master Facet.

47. The system of claim 46, further comprising a graphical representation of every relationship defined for each data item with other data items clustered under the same Master Facet, wherein each said relationship may be independently selected by the user for analysis.

48. The system of claim 41, further comprising a graphical representation for a relationship between said Master Facet and another Master Facet, said relationship having a plurality of attributes defined by the user, wherein said relationship and logical connection between said Master Facets are arbitrarily defined by the user, based on user's perception of the connection between them.

49. The system of claim 48, wherein the content of at least one of said Master Facets that are associated with each other is displayed when said attributes of the relationship between them are defined.

50. The system of claim 48, wherein every defined relationship between said Master Facet and other Master Facets is graphically displayed and may be independently selected by the user for analysis.

51. The system of claim 41, wherein a list of data items accessible to the user's computer may be browsed when the attributes of at least one said data item are being defined.

52. The system of claim 4 1, wherein at least partial content of at least one data item may be viewed while the relationship link between said data item and at least one other data item is displayed visually.

53. The system of claim 48, wherein at least partial content of a Master Facet may be viewed while the relationship link between said Master Facet and at least one other Master Facet is displayed visually.

54. The system of claim 41, wherein said data items comprise a plurality of heterogeneous multimedia data objects.

55. The system of claim 41, wherein at least one of said plurality of data items is an audio file.

56. The system of claim 41, wherein at least on of said plurality of data items is a digitized video file.

57. The system of claim 41, wherein at least one of said plurality of data items is an image file.

58. The system of claim 41, wherein at least on of said plurality of data items is an HTML file.

59. The system of claim 41, wherein at least on of said plurality of data items is a text file.

60. The system of claim 41, wherein at least one of said plurality of data items is associated with a particular application.

61. The system of claim 41, wherein at least one of said plurality of data items is a database object.

62. The system of claim 41, further comprising a graphical representation of a plurality of different types of data item attributes for assigning to data items.

63. The system of claim 62, wherein said plurality of different types of data item attributes are represented as icons, wherein at least one of said attributes may be assigned to a data item by dragging and dropping it into a visual representation of said data item.

64. The system of claim 41, further comprising a graphical representation of a plurality of different types of data item attributes for assigning to data classification clusters.

65. The system of claim 64, wherein said plurality of different types of data classification cluster attributes are represented as icons, wherein at least one of said attributes may be assigned to a Master Facet by dragging and dropping it into a visual representation of said Master Facet.

66. The system of claim 41, further comprising a graphical representation of a plurality of different types of attributes that may be assigned by the user to at least one relationship.

67. The system of claim 66, wherein said plurality of different types of attributes for the relationships are represented as icons, wherein at least one of said attributes may be assigned to a relationship by dragging and dropping it into a visual representation of said relationship.

68. The system of claim 41, further comprising an expert-system software component for analyzing the existing relationships between data items and assisting the user in defining the attributes of a new relationship between said data items based on the data acquired from said analysis of said other existing relationships.

69. The system of claim 68, wherein the expert-system software interacts with the user, and at least one attribute and the nature of at least one relationship between data items that are suggested by the expert-system are at least partially based on a response given by the user.

70. The system of claim 69, wherein the selection of at least one question presented to said user by said interactive expert system component is at least partially dependent upon a prior response given by said user.

71. The system of claim 41, wherein the Master Facets, data items and relationships are visually depicted in a tree format.

72. The system of claim 41, wherein the data items and relationships are visually depicted and organized as a scroll.

73. The system of claim 41, wherein at least one relationship defined by the user is stored in a scratch pad memory.

74. The system of claim 41, wherein at least one data item is stored in a temporary memory “coral” for connection to other data items at some later time.
